(19) United States
(12) Patent Application Publication
(10) Pub. No.: US 2025/0069470 A1
(43) Pub. Date: Feb. 27, 2025

(54) COMPUTER-IMPLEMENTED METHOD AND SYSTEM FOR ENABLING SIDE BETS WITH A CASINO OPERATOR IN A COMMUNAL POKER GAME

(71) Applicants: Eli Sompo, Jerusalum (IL); Aharon Malachi, Jerusalum (IL)

(72) Inventors: Eli Sompo, Jerusalum (IL); Aharon Malachi, Jerusalum (IL)

(21) Appl. No.: 18/811,655

(22) Filed: Aug. 21, 2024

Related U.S. Application Data
(60) Provisional application No. 63/520,805, filed on Aug. 21, 2023.

(51) Int. Cl. G07F 17/32

(52) U.S. Cl. CPC G07F 17/323; G07F 17/3209; G07F 17/3267; G07F 17/3293

(57) ABSTRACT

According to an aspect of the present invention, there is provided a computer-implemented method for enabling side bets with a casino operator in a communal poker game, comprising: displaying, on a graphical user interface at a player computer terminal, odds information to a player for one or more side bet(s); receiving, from the graphical user interface at the player computer terminal, an instruction from the player to place one or more side bet(s) according to the odds displayed; calculating, by a processor, one or more corresponding outcomes of the one or more side bet(s); displaying, on the graphical user interface at the player computer terminal, one or more outcome(s) of the one or more side bet(s); and displaying, on the graphical user interface at the player computer terminal, an updated balance of player funds based on the one or more outcome(s) of the one or more side bet(s).

### BACKGROUND

Poker is a well-known card game that comes in many variations. A feature common to most poker games is that the ranking of the final hands is based on poker hand ranking. A typical poker hand ranking, from highest to lowest by poker hand category, is: Royal Flush, Straight Flush, Four-of-a-Kind, Full House, Flush, Straight, Three-of-a-Kind, Two Pair, One Pair, and Highest Card in Hand. Often 2-10 players compete in a communal format to see who has the highest hand, although single-player games involving e.g., video poker terminals are also common.

Sometimes poker games take place at a venue, such as a casino, where all of the players physically gather together to participate. Often internet-based poker games are organized as well and played utilizing home computers or mobile devices and web-browsers or mobile applications. These games allow geographically disparate players to participate in poker games without having to travel to a particular venue.

### SUMMARY OF INVENTION

Therefore, the present invention can be implemented either in a poker game where all of the players are physical gathered on an adjacent computerized device or in an internet-based poker game.

In addition to the main wager on the outcome of a poker hand relative to competitors, poker players might desire to place supplementary wagers, sometimes called proposition wagers, on the occurrence or non-occurrence of specified events relating to cards appearing in the game. For example, a poker player might want to place a wager that the player will develop a hand including three cards of one number kind, e.g., three queens. This wager would be separate and additional to the wager on the poker player's hand relative to other players, and would generally be banked by the operator of the poker game, i.e., the owner or manager of the land-based casino or online casino.

Accordingly, an aspect of the present invention provides a computer-implemented method for enabling side bets with a casino operator in a communal poker game, comprising: displaying, on a graphical user interface at a player computer terminal, odds information to a player for one or more side bet(s); receiving, from the graphical user interface at the player computer terminal, an instruction from the player to place one or more side bet(s) according to the odds displayed; calculating, by a processor, one or more corresponding outcomes of the one or more side bet(s); displaying, on the graphical user interface at the player computer terminal, one or more outcome(s) of the one or more side bet(s); and displaying, on the graphical user interface at the player computer terminal, an updated balance of player funds based on the one or more outcome(s) of the one or more side bet(s).

According to another aspect of the present invention, there is provided a system, comprising: at least one input/output device(s) associated with and communicatively connected to a poker player computer terminal; a poker player computer terminal with a graphical user interface (GUI); a server; a database stored on a computer-readable medium; and at least one processor arranged to: display, on a graphical user interface at a player computer terminal, odds information to a player; receive, from the graphical user interface at the player computer terminal, an instruction from the player to place one or more side bet(s) according to the odds displayed; calculate, by a processor, one or more corresponding outcomes of the one or more side bet(s); display, on the graphical user interface at the player computer terminal, one or more outcome(s) of the one or more side bet(s); and display, on the graphical user interface at the player computer terminal, an updated balance of player funds based on the one or more outcome(s) of the one or more side bet(s).

### BRIEF DESCRIPTION OF THE DRAWINGS

FIG. 1 illustrates a side bet panel displaying, on a graphical user interface at a player computer terminal, odds information to a player for one or more side bet(s).

### DETAILED DESCRIPTION

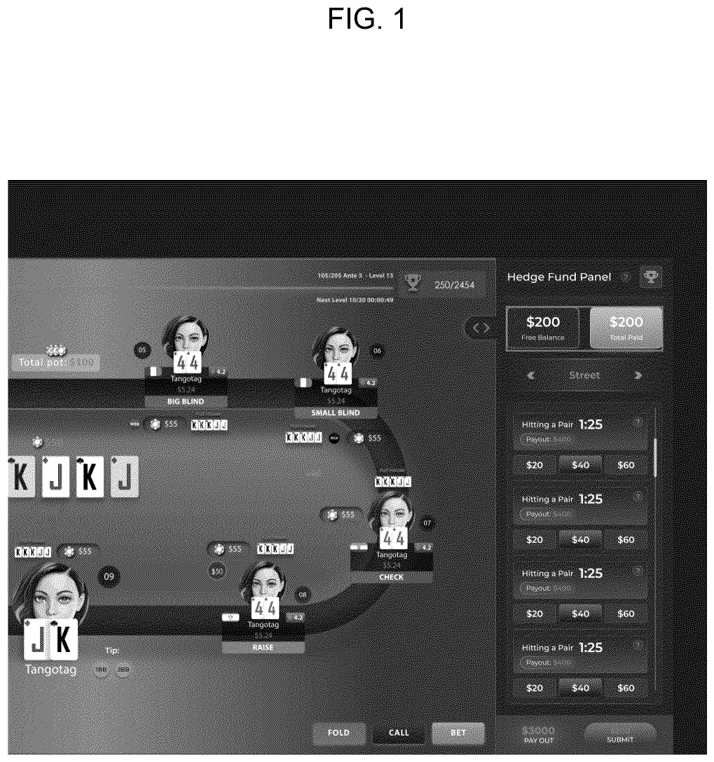

FIG. 1 illustrates a group of players at a poker table. In this embodiment, the poker table shown is on an internet poker site, but the present invention can also be implemented at a physical table arranged with computer devices according to the present invention. At a physical table, computer devices could be built into the table, attached to the table permanently or temporarily, or could be mobile devices owned by players, for example, mobile phones owned by players.

A main game is occurring (here, on an internet platform) and a side betting panel is positioned to the right side of the main game. The main game features a number of players in view competing to win a poker hand. A player can simultaneously make bets on a main hand and side bets at a single point in a poker game.

The side betting panel is the subject of the present invention. The side betting panel allows for additional wagers to be placed not necessarily against other players at the table, but against for example with the owner or operator of the poker site. As the example shows, it is possible to bet on “hitting a pair”. That is, the bet would encompass the poker player's hand matching two of the same value card, such as two Queens.

In embodiments, any number of side bets are possible. For example, a side bet could be offered that the next card to be dealt will be the Ace of Spades. Or a side bet could be offered that the next card will be a Club. In a hand where the player already holds the King of Spades, Queen of Spades, Jack of Spades, and Ten of Spades, the odds of the Ace of Spades being dealt on the next card could be equal to the odds of a Royal Flush.

In other cases, there may be multiple cards that could result in a Straight Flush, for example, i.e., either a Nine of Diamonds or a Four of Diamonds. The side betting panel can display betting odds of particular poker hands occurring as well as odds of specific card(s) being dealt, which are ultimately equivalent events just presented differently.

It is possible in various embodiments for bets to be placed before a hand or during a hand at various points of the course of play of a hand. For example, side bets could be placed on the values of the first two cards to be dealt, and side bets could continue up until the value of the last card. Multiple side bets could be possible on a single hand.

Depending on the unlikelihood of the event occurring, the betting odds could be higher or lower to provide incentive for the player to place the side bet. Betting odds could also be set according to the desired expected profitability of the owner or operator; that is, the desired gap between the true odds of the occurrence of a specified event with the cards and the posted betting odds on the side betting panel.

A variety of options for betting limits and betting inputs are possible in embodiments. As in the example of FIG. 1, there could be options to place bets for preselected amounts for the ease of operation, for example $20, $40, and $60. In other embodiments, it would be possible for a player to type in an amount to be bet according to the preference of the player, for example, a poker player might prefer to bet $17 rather than the $20, $40, or $60 provided as quick and convenient options.

As can also be seen on the side betting panel of FIG. 1, an updated balance of player funds based on outcome(s) of side bet(s) can be displayed. Fund balances displayed on the side betting panel could be separate fund balances from the player's fund balance for the main poker game, or the balances could be combined. Fund balances could be displayed in a variety of currencies both government-issued and cryptocurrency based as well as various point systems for example those used in poker tournaments.

The embodiments described above are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. A computer-implemented method for enabling side bets with a casino operator in a communal poker game, comprising:
displaying, on a graphical user interface at a player computer terminal, odds information to a player;
receiving, from the graphical user interface at the player computer terminal, an instruction from the player to place one or more side bet(s) according to the odds displayed;
calculating, by a processor, one or more corresponding outcomes of the one or more side bet(s);
displaying, on the graphical user interface at the player computer terminal, one or more outcome(s) of the one or more side bet(s); and
displaying, on the graphical user interface at the player computer terminal, an updated balance of player funds based on the one or more outcome(s) of the one or more side bet(s).

2. The method according to claim 1, further comprising:
calculating, by a processor, odds information to a player for one or more side bet(s) based on predetermined criteria stored in a computer memory format.

3. The method according to claim 2, wherein the processor is associated with a remote computer.

4. The method according to claim 3, further comprising transmitting the odds information.

5. The method of claim 1, wherein the one or more side bet(s) include a bet on whether a player will achieve a pair.

6. A system, comprising:
at least one input/output device(s) associated with and communicatively connected to a poker player computer terminal;
a poker player computer terminal with a graphical user interface (GUI);
a server;
a database stored on a computer-readable medium; and
at least one processor arranged to:
display, on a graphical user interface at a player computer terminal, odds information to a player;
receive, from the graphical user interface at the player computer terminal, an instruction from the player to place one or more side bet(s) according to the odds displayed;
calculate, by a processor, one or more corresponding outcomes of the one or more side bet(s);
display, on the graphical user interface at the player computer terminal, one or more outcome(s) of the one or more side bet(s); and
display, on the graphical user interface at the player computer terminal, an updated balance of player funds based on the one or more outcome(s) of the one or more side bet(s).

7. The system of claim 5, further comprising:
a communications link to one or more additional computer terminals belonging to other players in the poker game.

8. The system of claim 5, further comprising a dealer computer terminal displaying information about the poker player.

9. The system of claim 5, wherein the input/output device is a keyboard.

10. The system of claim 5, wherein is a mouse.

11. The system of claim 5, wherein the input/output device is a touchscreen.
